(19) United States
(12) Patent Application Publication
(10) Pub. No.: US 2004/0169308 A1
(43) Pub. Date: Sep. 2, 2004

(54) Apparatus and method for producing a tube of varying cross-section

(75) Inventors: J. Rae Walker, Rolling Hills, CA (US); David S. Paul, Downey, CA (US)

Correspondence Address: OSTROLENK FABER GERB & SOFFEN, 1180 AVENUE OF THE AMERICAS, NEW YORK, NY, 100368403

(73) Assignee: Axiom Medical Inc.

(21) Appl. No.: 10/753,778

(22) Filed: Jan. 8, 2004

Related U.S. Application Data
(60) Provisional application No. 60/439,006, filed on Jan. 9, 2003.
(60) Provisional application No. 60/439,316, filed on Jan. 9, 2003.

(51) Int. Cl. B29C 47/20; B29C 47/88; B29C 47/90

(52) U.S. Cl. 264/167; 264/209.3; 264/211.12; 264/211.2; 264/236; 425/363; 425/378.1; 425/380

(57) ABSTRACT

An apparatus for producing a tube having a round cross-section over a major portion of its length and intermediate its ends having a flattened oval cross-section. The apparatus includes an extrusion head with an extrusion die through which the tube is extruded. A pinching device, which includes opposed pinching elements, is arranged at the extrusion head so as to be selectively moveable together to press on and pinch the tube to produce the oval cross-section of the tube. The rollers are selectively moveable apart to not pinch the tube to enable the tube to be extruded round, whereby a round tube with an intermediate flattened oval shaped portion is produced.

### CROSS-REFERENCE TO A RELATED APPLICATION

This application is based upon and claims priority of U.S. Provisional Applications Serial Nos. 60/439,316 and 60/439,006, both filed Jan. 9, 2003, incorporated by reference.

### BACKGROUND OF THE INVENTION

### FIELD OF THE INVENTION

The invention concerns a method and apparatus for the manufacture of a tube, for example for use as a chest drain.

A chest drain is a chest tube, which most commonly passes between two ribs to access the chest cavity. Chest tubes usually but not always have a round cross-section.

A conventional, round drain tube is made of plastic, rubber or silicone and is usually extruded. As the tube exits from an extruder head vertically, it travels up past an antistat bar, and through a heater. The tube then passes over one or more take-up wheels before being coiled and/or cut. The speed at which the silicone extrusion travels as it exits the extruder head can vary, but the operator manually adjusts the speed of the take-up wheel or wheels to match the speed required to accommodate the tube.

### SUMMARY OF THE INVENTION

It is an object of the present invention to provide a tube that has a section which is flattened into an oval shape. This flattened section is located so that in a chest tube, for example, it is the portion of the tube between the ribs when the drain is in place. The reduced thickness of the flattened section applies less pressure on the periosteum of the rib bones of the patient, reducing discomfort while it is in place. The flattened section is approximately four inches in length.

Pursuant to this object, and others which will become apparent hereafter, one aspect of the present invention resides in an apparatus for producing a tube having a round cross-section over most of its length and having a portion with a flattened oval cross-section. The tube is made from silicone or another extrudable material. The apparatus includes an extrusion head with an extrusion die with which the tube is extruded. A pinching device has opposed pinching elements arranged at the extrusion head so as to be movable together to press on and pinch the tube to thereby produce the oval cross-section of the tube, and so as to be selectively movable apart to not pinch the tube to enable it to be extruded with the round cross-section. Thus, a round tube with an intermediate flattened oval-shaped portion is produced.

The tube is pinched before curing, thus taking on an oval-shaped cross-sectional shape. The tube is then heat-cured so as to retain that shape.

In another embodiment of the invention, the pinching elements are a pair of opposing rollers that are selectively movable into engagement with the tubing. In yet a further embodiment of the invention, actuators are operatively connected to the rollers for moving the rollers into contact with the tubing and out of contact with the tubing. The actuators may be controlled by a programmable logic controller that is connected to a rotary encoder attached to a take-up wheel for the tubing. The rotary encoder measures rotation of the take-up wheel and transmits data corresponding to a length of tubing which is taken up to the logic controller for controlling operation of the actuators.

In an appropriate case, if desired, the actuators could be operable manually as well.

The flattened portion of the drain tube is made by pinching the tubing with two opposing rollers as the tubing exits the extruder. The rollers are controlled by an automated system, which will automatically adjust the length of time the rollers pinch, based on the rotation of the extruder take-up wheel. Assuming there is no slip between the take-up wheels and the tube, it is calculated how many degrees of rotation is equivalent to form a desired pinch length on the tube.

First the circumference of the take-up wheel is calculated:

C=2πr

Where: C=circumference

r=radius of take-up wheel

Then using the principle of proportion, the degree of rotation may be calculated for any desired length of tube. If the flattened portion is 4 inches, then the equation is:

C/4 inches=360°/x°

Where: C=circumference of take-up wheel

x—degrees of rotation required for 4 inches of tubing

Solving the above equation for x gives:

x=360°·[(4 inches)/C]

For example, with a take-up wheel radius of 1.75 inches, the amount of rotation of the wheel required for 4 inches of tubing is approximately 129°. This is the amount of rotation during which the rollers are activated to press in on the tubing. A similar calculation is performed to determine the amount of rotation required until the rollers retract, and let the tubing resume its round shape.

The method has several advantages over the known art. In order to produce a tube with a narrowed portion, one known method would draw the tube with greater tension as it exits the extruder for a predetermined time, in order to make a portion of the tube smaller. Another known method uses an extruder which itself has an adjustable nozzle which is adjustable to vary the outer dimensions of the extruded tube. Both of these methods have a disadvantage of changing the wall thickness and/or the cross-sectional area of the tube in order to provide a reduced dimension. The pinching technique of the present invention, however, in order to reduce an outside dimension of the tube, does not substantially reduce either the wall thickness or the cross-sectional area of the tube, which would weaken the tube. This pinching technique leaves the integrity and function of the tubing relatively unchanged.

Thus the extrusion process can be carried out continuously and at a constant speed. There is no need to vary the tension applied by the take-up rollers during the pinching process, because the pinch rollers do not cause any drag on the extrusion product and a constant volume of silicone or other extrudable material is continuously delivered.

The method also produces smooth transition zones at the inside and outside surfaces of the tube between the portions of different diameters, reducing turbulence of conducted material.

For a more complete understanding of the apparatus and method for producing a tube of a varying cross-section of the present invention, reference is made to the following detailed description and accompanying drawings in which the presently preferred embodiments of the invention are illustrated by way of example. That the invention may be embodied in several forms without departing from the spirit or essential characteristics thereof, it is expressly understood that the drawings are for purposes of illustration and description only, and are not intended as a definition of the limits of the invention. Throughout the following description and drawings, identical reference numbers refer to the same component throughout the several views.

### BRIEF DESCRIPTION OF THE DRAWINGS:

FIG. 1 is a view of a drain tube produced pursuant to the present invention;

FIG. 2 is a cross-section along the line A-A in FIG. 1;

FIG. 3 is a cross-section along the line B-B in FIG. 1;

FIG. 4 is an expanded view C of FIG. 1;

FIG. 5 is a top view of an apparatus pursuant to the present invention;

FIG. 6 is an elevational view of the apparatus of FIG. 5;

FIG. 7 is a side view of the apparatus of FIG. 6; and

FIG. 8 is an expanded view of the mounting brackets for an actuator.

### DETAILED DESCRIPTION OF EMBODIMENTS OF THE INVENTION

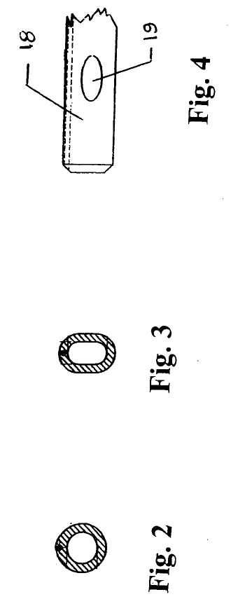

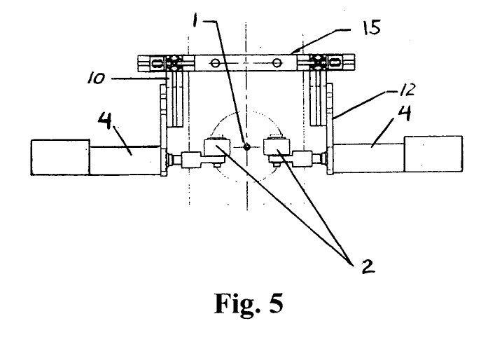

The tooling for carrying out the inventive method includes two rollers 2, made for example of urethane, which are attached to electric actuators 4. The actuators 4 are controlled by a PLC (programmable logic controller) 20 with a touch-screen operator interface. The PLC receives data from a rotary encoder 6 attached to the axle of the take-up wheel 8. After the correct amount of rotation has occurred, the actuators 4 press the rollers 2 inwardly against the silicone extrusion 1, changing the shape of the tube from round as shown in FIG. 2 to oval as shown in FIG. 3. After a further selected amount of rotation, the actuators 4 move the rollers 2 outward again, so that the tubing 1 returns to round shape. The actuator parameters may be adjusted by the operator using the touch-screen interface. After leaving the rollers 2, the tubing 1 passes through an oven 22 where it is cured.

The actuators are mounted to the extruder head using three slotted aluminum struts 10. These struts 10 allow for approximately 1.5 inches of adjustability in all 3 axes, should the need arise.

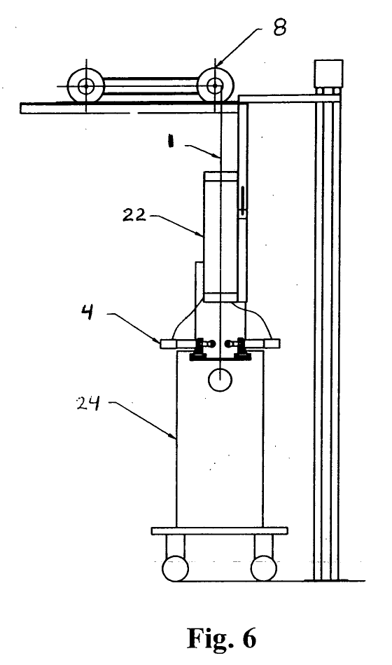

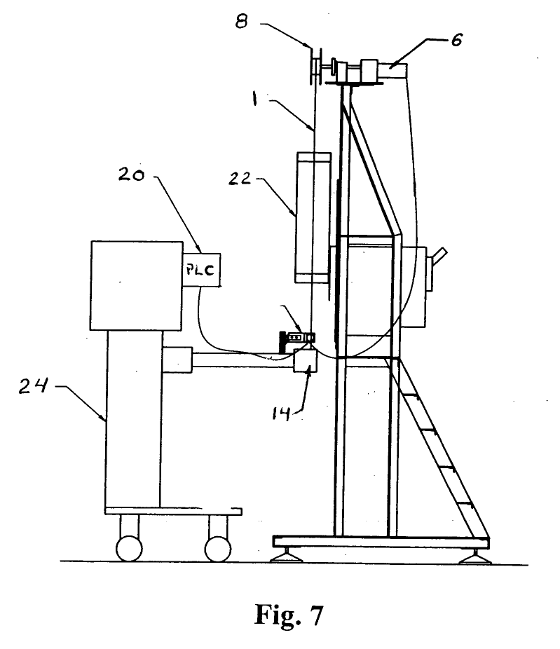

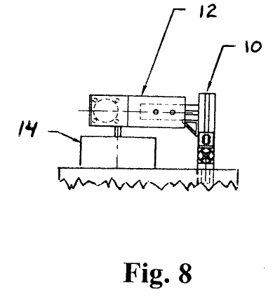

Each actuator 4 is mounted to the struts 10 by a mounting plate 12. The struts are in turn mounted to a base plate 15 which is mounted to the extruder 24 so that the extrusion head 14 is centered between the rollers 2 (see FIGS. 6-8). The whole assembly mounts to the extruder using two bolts, which minimizes the setup time. Other quick-mounting arrangements are of course available and are considered to be within the scope of the invention.

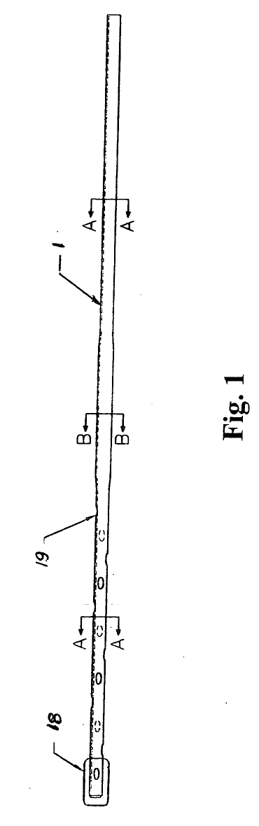

The extruded tube 1, shown in FIG. 1, produced with the tooling described has a normal circular cross-section, as shown in FIG. 2, and where required, the cross-section of the tube is flattened and deformed into the oval shape, as shown in FIG. 3, for a predetermined length, where the tube will lie between the ribs or other constricted space when the tube is in place. As described above, the technique of producing the flattened oval shaped region is usually applied only over a predetermined length of the tube which would normally be otherwise round. As seen in FIG. 1, the end of the tube has a beveled tip 18 and drain holes 19 are provided in a portion of the tube which is internal to the body during use.

Although the present invention has been described in relation to particular embodiments thereof, many other variations and modifications and other uses will become apparent to those skilled in the art. Therefore, the present invention is not limited by the specific disclosure herein.

What is claimed is:

1. An apparatus for producing a tube having a round cross-section over a major portion of its length and intermediate its ends having a flattened oval cross-section, the apparatus comprising:
an extrusion head with an extrusion die through which the tube is extruded; and
a pinching device including opposed pinching elements arranged at the extrusion head so as to be selectively moveable together to press on and pinch the tube, for thereby producing the oval cross-section of the tube and so as to be selectively moveable apart to not pinch the tube to enable the tube to be extruded round, whereby a round tube with an intermediate flattened oval shaped portion is produced.

2. The apparatus of claim 1, wherein the pinching elements are a pair of opposing rollers selectively moveable into engagement with the tubing extruded in the extrusion head for pinching the tube between the rollers as they rotate with the tubing, and the rollers being moveable off the tubing.

3. The apparatus of claim 2, wherein the rollers are urethane rollers.

4. The apparatus of claim 2, and further comprising actuators operatively connected to the rollers for moving the rollers.

5. The apparatus of claim 4, and further comprising a programmable logic controller operative to control the actuators.

6. The apparatus of claim 5, and further comprising a take-up wheel on which the tube is windable after production, and a rotary encoder attached to an axle of the take-up wheel and connected to the programmable logic controller so as to transmit data thereto.

7. The apparatus of claim 6, wherein said controller is operable to calculate an amount of take-up wheel rotation corresponding to a length of tubing to be formed with said oval shape.

8. The apparatus of claim 4, wherein each of the actuators is mounted to the extruder head.

9. The apparatus of claim 8, wherein the actuators are mounted to the extruder head by three slotted struts which are configured to adjustably align the actuators in three axes.

10. The apparatus of claim 1, further comprising a heating device downstream from said extrusion head for heat-curing said tubing, said pinching device being located between said extrusion head and said heating device.

11. A method for forming a tube having a normally round internal and external cross-section and an intermediate region which is flattened to an oval cross-section, wherein the method comprises:
extruding extrudable tubing material through an extrusion die to produce a tube with a round cross-section; and
periodically pinching the tube between opposing pinching elements after the tubing exits the extrusion die.

12. The method of claim 11, further comprising the step of selecting the period of time which the pinching elements pinch the tubing as a function of the speed of the tubing.

13. The method of claim 12, further comprising winding the extruded tubing on a take-up wheel and determining an amount of rotation of the wheel dependent upon a circumference of the wheel in response to a length of the tubing which is to be pinched.

14. The method of claim 11, further comprising the step of heat-curing the extruded tubing following said pinching step.

15. The method of claim 11, wherein said pinching step is performed so that said round and said flattened portions of said tube have substantially the same wall thickness and internal cross-sectional area.

16. The method of claim 11, wherein said extrudable tubing material is silicone.

17. The apparatus of claim 1, wherein said pinching device is operable so that said round and said flattened portions of said tube have substantially the same wall thickness and internal cross-sectional area.

18. The apparatus of claim 1, in combination with an extrudable silicone material for being extruded by said extrusion head.
